(19) United States
(12) Patent Application Publication
(10) Pub. No.: US 2004/0035888 A1
(43) Pub. Date: Feb. 26, 2004

(54) Replacement caulking tube nozzle

(76) Inventor: Mark C. Chick, Florissant, MO (US)

Correspondence Address: Paul M. Denk, 763 S. New Ballas Road, St. Louis, MO, 63141, US

(21) Appl. No.: 10/407,707

(22) Filed: Jul. 7, 2003

Related U.S. Application Data
(60) Provisional application No. 60/370,765, filed on Apr. 9, 2002.

(51) Int. Cl. G01F 11/30

(52) U.S. Cl. 222/327; 222/569

(57) ABSTRACT

A replacement caulking tube nozzle, having a nozzle portion, integrally formed with a base, having a connecting lip extending downwardly therefrom, the lip intended for inserting within the end of a cut or severed caulking tube, in order to eliminate any of the hardened caulk, from plugging up the tube for further usage. Where the lip of the replacement nozzle is applied internally of the tube, for the replacement nozzle, it may include a flange that biases against the end of the tube to act as a further seal against leakage of caulking material from the tube upon the application of pressure through operation of the caulking gun.

### BACKGROUND OF THE INVENTION

This invention relates primarily to a caulking tube for use with a caulking gun, and more specifically relates to a replaceable form of nozzle that can be used in conjunction with a previously opened tube of caulking to allow for immediate discharge of caulk, without obstruction.

This invention further relates to a universal caulking gun, which is applied after the factory installed nozzle becomes clogged with dried caulk or other material. After a caulking or similar tube seal is initially punctured, and the material, such as caulking is discharged through the nozzle, at the end of the tube, the unused portion will eventually harden and make it impossible to dispense and use the remaining portion at a later date. This particularly becomes a problem especially when the caulking tube is left to lie, as for example, in a cold garage, over the winter, and is not applied again until the spring or summer.

There are various nozzles which are designed to eliminate this problem. Most of these types of prior art nozzles screw or break off the end of the tube, so that the hardened material can be removed from the nozzle or simply replace the nozzle upon the tube. For example, this can be seen in the U.S. Pat. No. 4,284,213, U.S. Pat No. 5,833,099, U.S. Pat. No. 4,957,225 and U.S. Pat. No. 5,560,521. The problem with these designs is that it only works on tubes manufactured with a particular style of nozzle, and the hardened material in the proximate end of the cartridge cannot be otherwise removed.

Other patents, such as U.S. Pat. No. 4,876,757, is designed to retrofit any caulking tube, suggesting that cutting off the nozzle of the tube and threading to the remaining portion of the nozzle, allows for the after market nozzle to be screwed into the newly threaded portion. A further patent, U.S. Pat. No. 2,953,285, shows that the factory installed nozzle may be cut off, and replaced with a slightly larger nozzle over the original. The problem with these designs are, if the material has hardened below the cut portion of the nozzle, or the material has hardened within the upper end of the tube, the hardened material cannot be removed through such a small opening, where the nozzle was cut off. This same type of predicament prevails with the replaceable type of nozzles as explained in the previously identified patents, in that the replacement is done at the nozzle level, and not at the upper end of the tube where all of the hardened material can be removed, providing access to the remaining fresh and soft part of the caulk for ready usage.

This current invention allows the worker to even cut off the caulking tube, wherever the hardened material ends, and thereby install a new nozzle at that point, even if it means cutting the tube off in half. Furthermore, even cutting off that amount or segment of the caulking tube itself, and replacing with a nozzle portion of the type of this design, still allows the remaining caulking tube to be used and applied within one of the standard caulking guns, since the reach of the standard caulking gun piston is for its full length, regardless of how long of a tube may remain within the cradle, during usage of the standard formed caulking gun.

### BRIEF SUMMARY OF THE INVENTION

This invention contemplates the usage of a standard caulking tube, one which holds the fresh and pliable caulk therein, and which can be dispensed through usage and application of a caulking gun. The replacement caulking tube nozzle of this invention includes what is configured to be a standard type of nozzle, having a length of two to four inches, as known in the art, but has integrally formed therewith a base portion, having a lip integrally extending downwardly therefrom, and which is designed to mate either within or exteriorly but in very close contiguous contact for a slight pressure fit, the end of the caulking tube where it has been cut, to expose the remaining pliable portion of the caulk, for further usage and application. The entire unit may be integrally formed, the lip that extends from the base will either snuggly fit within the end of the cut tube, and thereby function as a nozzle end for the remaining portion of the caulking tube or it may slide snuggly over its exterior surface, and in that manner, generally prevents the oozing or creeping of any of the remaining caulk subject to pressure of the gun, from easing out of the tube at that location, since the caulk still have a very free and clear path out of the end of the nozzle, when compressed by the caulking gun.

In that instance where the lip of the replacement nozzle extends internally of the tube, and its end, there is integrally provided a slight flange around the perimeter of the base, or the base simply extends out to that distance, as to furnish an overlying of at least the end of the tube, to provide a slight additional seal at that location, to prevent the oozing of the caulking material from the tube at this location, when pressure is applied therein, and substantially directs all of the caulk out the end of the replacement nozzle, for continued usage and application.

It is, therefore, the principal object of this invention to provide a replacement nozzle for a caulking tube.

Still another object of this invention is to provide a replacement nozzle that obviates the need to dispense with or throw away a half used tube of caulking simply because some of the caulking at the nozzle end has hardened and has formed a plug thereat.

Yet another object of this invention is to provide means for quickly severing the end of caulking tube to eliminate any hardened plugged caulking material, and allow the application of the replacement nozzle of this invention for immediate re-usage and application of the caulking tube.

Still another object of this invention to provide a replacement for a caulking tube that may be very quickly and easily applied, eliminating the need to throw away used tubes of caulk that still have a substantial amount of fresh and pliable caulk therein, but which cannot be otherwise dispensed.

These and other objects may become more apparent to those skilled in the art upon review of the summary of this invention, and upon undertaking a study of the description of the preferred embodiment, in light of the drawings.

### BRIEF DESCRIPTION OF THE SEVERAL VIEWS OF THE DRAWINGS

In referring to the drawings, FIG. 1 is an isometric view of a caulking tube of this invention;

FIG. 2 shows the caulking tube of FIG. 1, wherein its front nozzled end that contains the hardened end of caulk is being severed therefrom in preparation for usage of the replacement nozzle of this invention;

FIG. 3 shows the severed end of the caulking tube, with the removed end of the nozzle being disposed of;

FIG. 4 shows the replacement nozzle of this invention in the process of being applied to the end or the severed end of the caulking tube; and

FIG. 5 shows a sectional view of the replacement nozzle of this invention.

### DESCRIPTION OF THE PREFERRED EMBODIMENT

In referring to the drawings, and particular FIG. 1, shows a typical cartridge containing caulk or other material 6, as is normally discharged from the end of the tube 1, through the standard integrated nozzle 2, by means of any standard caulking or dispensing gun. In practice, after the nozzle 2 has been initially cut, and some of the material 6 has been forced from the end of the tube by means of the application of the caulking gun, such material is pressured through the nozzle 2, as known in the art. After the tube is used for some time, or even for a short time, following severance of its nozzle, and left to lie for some period of time, particularly in colder climates, frequently the remaining material 6, held within the tube 1, becomes hardened over time, at the region of its exposure to the atmosphere, as through the severed end of the nozzle 2, and such hardened material plugs up the nozzled end of the tube, making it near impossible, if not prevents a forcing of the remaining material 6 through the nozzle 2, out of the tube 1 during continued usage. When this occurs, the user will normally apply excessive pressure through the trigger to, the plunger portion of the gun, until such time as either the tube cracks, thereby spreading caulking material all over the side of the gun, or the caulking material will break the seal at the back of the tube, likewise spreading caulking material around the gun, and making it unuseful. It then takes substantial time to clean the gun and get all the caulk off the user's hands, before a new tube is cut and readied for application.

As reviewed in the summary of this invention, it is the purpose of this development to provide a replacement nozzle that can be quickly applied to the end of the severed or cut tube, at the region where the caulking still remains pliable, and immediately operate the gun to dispense additional of the remaining soft caulk, during usage and application.

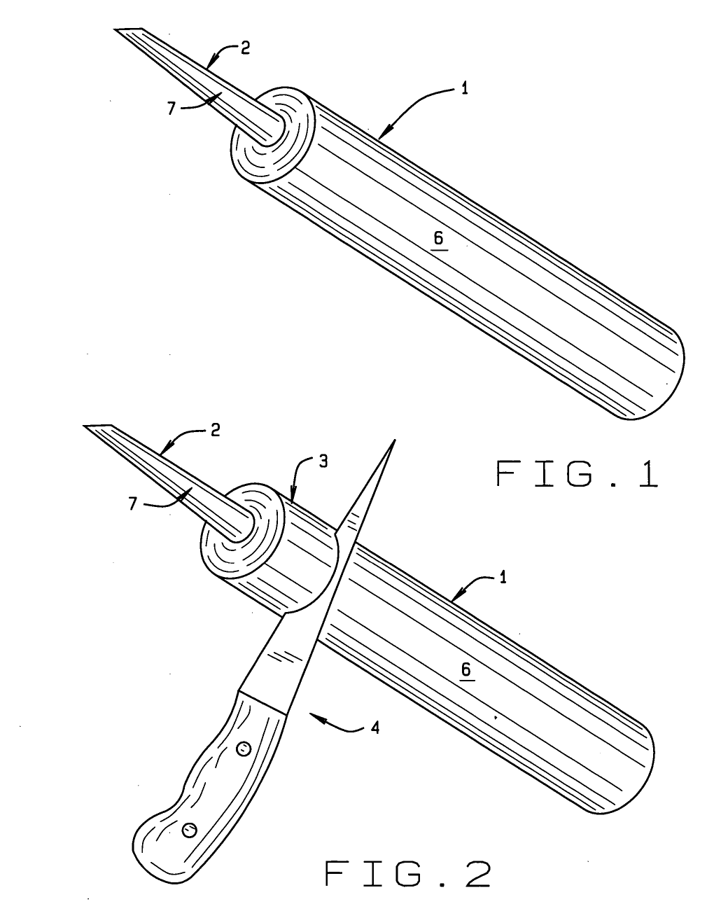

As can be seen in FIG. 2, the user estimates that the approximate location of the end of the hardened caulk within the tube and then severs the tube at that location, to expose the remaining pliable and yet useable caulk. Or, if the user simply cuts the tube at its end, just below the nozzle, it will be much easier to pull out the hardened plug of caulking material to expose the remaining soft caulk. At this time, the replacement nozzle of this invention may be applied, and the remaining tube of caulk reinserted into the gun, for ready dispensing.

As noted in FIG. 2, a standard knife 4 is used to sever the tube, diametrically just below the hardened material, which by this time will be located at 7 within the nozzle, and even extend down into the upper end of the tube as can be understood. Once the tube 1 is severed, the upper end 3 is cut free, it is discarded. This leaves only the lower section of the tube 1, with the usable pliable caulking material 6 therein, ready for application of the replaceable nozzle of this invention.

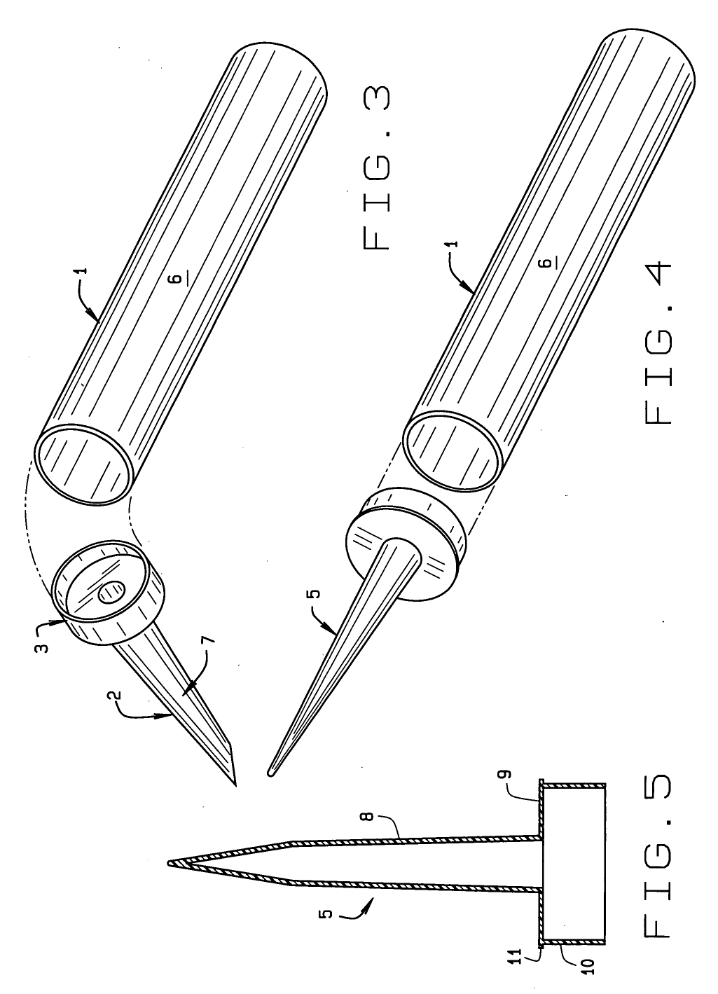

As can be seen in FIG. 3, the top end of the tube 1, along with the existing and original nozzle 2, and any hardened material 7, remaining therein, is now separated from the tube 1, as the segment 3, and is discarded. This leaves only the lower section of the tube 1, and the remaining useable and pliable caulking material 6, for continued application.

As noted in FIG. 4, a new replacement nozzle 5 is inserted into the top of the tube 1, allowing for the usable material 6 to be forced through the application of pressure by the caulking gun, through the new nozzle 5, after the tip of the nozzle 5 has been cut to provide a dispenser opening as known in the art. These tips are normally cut off providing an opening size properly for the particular demands of the job required to be caulked.

As can be seen in FIG. 5, the replacement caulking tube nozzle of this invention is readily disclosed, in cross section. It includes an integral nozzle portion 8, having a connected base 9, and integrally extending downwardly from the base 9 is the lip 10 as can be seen. There is a slight flange 11 that extends around the circumference of the base 9, and this flange is designed for biasing against the upper cut edge of the tube 1, after it has been severed, and the lip 10 is tightly and snuggly inserted within the open and cut end of the tube, in a manner as previously explained.

Or, in the alternative, it is just as likely that the lip 10 may be slightly larger the outside diameter of the cut end of the tube, so that it will snuggly fit over the outward edge of the tube, and when this embodiment is employed, the base 9 need not have the integral flange 11, since it is not needed to bias against the end of the tube, since the lip 10 will slide over the exterior of the tube, rather than within the same, as described for the preferred embodiment.

Nevertheless, as previously explained, it is desirable that the lip 10 snuggly fit either within or exteriorly of the end of the tube so as to minimize the creep or oozing of any of the caulking material from this region of the tube-replacement nozzle interface, but rather, when pressure is applied to the caulk, by means of the piston of the caulking gun, it will simply exit out the end of the tube, through its nozzle 8, in a manner as known in the art.

Variations or modifications to the subject matter of this invention may occur to those skilled in the art upon review of the development as provided herein. Such variations, if within the spirit of this development, are intended to be encompassed within the scope of the invention as described. The summary of the invention as provided herein, and even the depiction of the preferred embodiment, in view of the drawings, is set forth for illustrative purposes only.

1. For use in combination with a caulking tube wherein a portion of the caulk at the front of the tube has become hardened due to ambient exposure, and wherein the front of the caulking tube has been cut off to remove said hardened caulk, a replacement caulking tube nozzle for use in application with the cut caulking tube, said replacement caulking tube nozzle including a nozzle portion, said nozzle having an inner passage through which fresh and pliable caulk may pass, for discharge out of the nozzle tip, said nozzle being connected with a base, an integral sleeve extending downwardly from said base, said integral sleeve provided for operatively connecting with the cut end of the caulking tube to allow for its installation within a caulking gun and for dispensing of caulk from the tip of said replacement nozzle.

2. The replacement caulking tube nozzle of claim 1 wherein the sleeve portion contiguously slides tightly over the cut end of the caulking tube.

3. The replacement caulking tube nozzle of claim 1 wherein the sleeve portion contiguously slides tightly within the cut end of the caulking tube.

4. The replacement caulking tube nozzle of claim 3 and including a flange extending around the perimeter of the base externally of the sleeve portion of the replacement nozzle, said flange disposed for pressured engagement with the cut end of the caulking tube when said caulking tube and its replacement nozzle are applied within a caulking gun and the gun is operated to press caulk from the caulking tube.
